(19) United States
(12) Patent Application Publication
(10) Pub. No.: US 2005/0022222 A1
(43) Pub. Date: Jan. 27, 2005

(54) Disk support mechanism, optical disk drive and motor unit

(75) Inventor: Hideo Yamasaki, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/891,499

(22) Filed: Jul. 15, 2004

(30) Foreign Application Priority Data
Jul. 15, 2003 (JP) 2003-197399

(51) Int. Cl. G11B 17/22

(52) U.S. Cl. 720/707

(57) ABSTRACT

An optical disk drive includes a motor base, a rotational shaft that is rotatably held on the motor base, a rotor that is fixed to the rotational shaft and is rotated when supplied with a magnetic field, a stator that is provided in a space between the rotor and the motor base and is capable of applying a magnetic field to the rotor, and a drive circuit that is provided on a region on the motor base, which is outside a region defined by projection of the rotor, and causes a magnetic field to be produced from the stator.

### CROSS-REFERENCE TO RELATED APPLICATIONS

This application is based upon and claims the benefit of priority from prior Japanese Patent Application No. 2003-197399, filed Jul. 15, 2003, the entire contents of which are incorporated herein by reference.

### BACKGROUND OF THE INVENTION

1. Field of the Invention

The present invention relates generally to an optical disk drive that reproduces information from an optical disk, which is an information recording medium, or records information on the optical disk, and to an information recording/reproducing apparatus that employs the optical disk drive.

2. Description of the Related Art

Optical disks, which have widely been used, fall into three categories: read-only type, typified by a CD and a DVD-ROM; write-once type, typified by a CD-R and a DVD-R; and rewritable type, typified by an external storage of a computer and recording/reproducing video media.

An optical disk drive, which reproduces information from an optical disk or records information on the optical disk, is required to have a smaller thickness, less power consumption and a lighter weight. A demand for smaller thickness is particularly strong with respect to an optical disk drive that is so designed as to be built in a portable device.

An optical disk rotating device (spindle motor) is one of factors that determine the thickness of the optical disk drive. A turntable that holds an optical disk and a chucking mechanism that fixes the optical disk to the turntable are integrally formed to the shaft of the spindle motor.

Thus, in order to reduce the thickness of the optical disk drive, it is necessary to reduce the thickness of the spindle motor and the thickness of the turntable and chucking mechanism.

The chucking mechanism, however, is required to chuck the optical disk set on the turntable so as to prevent undesirable removal of the optical disk. If the optical disk set on the turntable rotates idly, this would lead to an error in reading data recorded on the optical disk or an error in recording data on the optical disk. The chucking mechanism is thus required to hold the optical disk on the turntable.

On the other hand, as is well known, if the force, with which the chucking mechanism holds the optical disk on the turntable, is too strong, the optical disk warps considerably in its radial direction due to a force of reaction from the turntable. This leads to an error in reading/recording.

An optical disk clamp mechanism has already been proposed (e.g. Jpn. Pat. Appln. KOKAI Publication No. 10-124967 (see claims 1 and 2, FIG. 1, paragraph [0017]). This clamp mechanism includes a clamp member that clamps an optical disk on a turntable and a level difference part that corrects the curving of the optical disk.

When the level difference part for correcting the curving of the disk, as disclosed in Jpn. Pat. Appln. KOKAI Publication No. 10-124967, is provided, the following problems will arise:
1) A reaction force against the pushing force by the claw occurs at the level difference part with a very small area. Consequently, a disk slip tends to easily occur when the motor is driven or when the rotation speed of the motor varies.
2) Since the level difference part is located at a radially inner position, the disk tends to incline due to non-uniformity in height of the level difference part or non-uniformity in thickness of the radially inner part of the disk.

In the prior art, if the inside diameter of an annular rubber member, which is used for preventing slip of the disk, is made less than the radius of the disk, the following problem arises. That is, since precision in height of a chucking holder for slidably holding the chucking claw is not secured, the chucking force becomes non-uniform, which leads to wobbling or disengagement of the disk due to inadequate chucking force, or a curving of the disk due to excessive chucking force.

Specifically, the height of the claw that produces the chucking force is determined by the height of the radially inside part of the chucking holder that slidably holds the claw. This requires some devices that are to be made to the chucking holder provided near the radially inside part of the disk and to the shape of the rubber member.

One factor of the occurrence of curving of the optical disk that is set and chucked on the turntable is as follows. Since the thickness of the turntable and chucking mechanism is reduced, a bending moment occurs due to the direction of force (toward the turntable) that is exerted on the optical disk from the chucking mechanism and the direction of force (toward the chucking mechanism) that is exerted on the optical disk from the turntable.

### BRIEF SUMMARY OF THE INVENTION

According to an aspect of the present invention, there is provided a disk support mechanism comprising: a turntable having a surface extending perpendicular to a rotational shaft thereof, the turntable supporting a to-be-supported object; a claw member that applies an urging force in a direction parallel to the rotational shaft, with the object interposed between the turntable and the claw member; and an elastic member that is formed on the turntable concentrically with the rotational shaft and produces a force of reaction capable of relaxing a bending moment that is caused by a reaction to the urging force in the direction parallel to the rotational shaft.

According to another aspect of the present invention, there is provided an optical disk drive comprising: a disk motor including (i) a motor base that rotatably holds a rotational shaft, (ii) a rotor fixed to the rotational shaft, (iii) a medium holding mechanism that is able to apply an urging force to the rotor in a direction parallel to an axis of the rotational shaft, at a predetermined radial position from a center of the rotational shaft, and positions a recording medium so as to be rotatable along with the rotor, and (iv) an elastic member that is formed on the rotor concentrically with the rotational shaft and applies to the medium holding mechanism a force of reaction capable of relaxing a bending moment that is caused by a reaction to the urging force from the medium holding mechanism, in a state in which the recording medium is interposed between the medium holding mechanism and the elastic member, the elastic member having a sheet-like shape and including an outside diameter portion defined by a first radius from the rotational shaft, an inner peripheral portion defined by a second radius that is less than the first radius of the outside diameter portion, and an reaction portion defined by a third radius that is less than the second radius of the inner peripheral portion; an optical head that emits light to the recording medium and reproduces information recorded on the recording medium on the basis of the light reflected by the recording medium; and a motor control unit that rotates the disk motor at a predetermined speed.

According to further another aspect of the present invention, there is provided a disk support mechanism comprising: a turntable having a surface extending perpendicular to a rotational shaft thereof, the turntable supporting a to-be-supported object; a claw member that applies an urging force in a direction parallel to the rotational shaft to the to-be-supported object that is loaded on the turntable; a claw height restricting member that keeps at a predetermined value a distance between the claw member and the turntable; and an elastic member that is formed on the turntable concentrically with the rotational shaft and produces a force of reaction capable of relaxing a bending moment that is caused by a reaction to the urging force in the direction parallel to the rotational shaft.

According to another aspect of the present invention, there is provided a disk support mechanism comprising: a turntable having a surface extending perpendicular to a rotational shaft thereof, the turntable supporting a to-be-supported object; a support member that is disposed on the turntable concentrically with the rotational shaft and applies, when the to-be-supported object is loaded, a force to the to-be-supported object at least at three locations, the force acting in an axial direction of the rotational shaft away from the surface of the turntable; and a disk chucking member that receives the force from the support member and produces a force of reaction capable of putting the to-be-supported object in close contact with the support member.

According to further another aspect of the present invention, there is provided a motor unit comprising: a motor base; a rotational shaft that is rotatably held by the motor base; a rotor fixed to the rotational shaft; a medium holding mechanism that is able to apply an urging force to the rotor in a direction parallel to an axis of the rotational shaft, at a predetermined radial position from a center of the rotational shaft, and positions a recording medium so as to be rotatable along with the rotor; and an elastic member that is formed on the rotor concentrically with the rotational shaft and applies to the medium holding mechanism a force of reaction capable of relaxing a bending moment that is caused by a reaction to the urging force from the medium holding mechanism, in a state in which the recording medium is interposed between the medium holding mechanism and the elastic member, the elastic member having a sheet-like shape and including an outside diameter portion defined by a first radius from the rotational shaft, an inner peripheral portion defined by a second radius that is less than the first radius of the outside diameter portion, and an reaction portion defined by a third radius that is less than the second radius of the inner peripheral portion.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic view illustrating an example of an optical disk drive according to an embodiment of the present invention;

FIG. 2A and FIG. 2B are a schematic view illustrating an example of a chucking mechanism that is built in the optical disk drive shown in FIG. 1;

FIG. 3 is a schematic view illustrating another example of the chucking mechanism shown in FIG. 2A and FIG. 2B;

FIG. 4A and FIG. 4B are a schematic cross-sectional view illustrating the structure of the chucking mechanism shown in FIG. 3; and

FIG. 5 is a schematic block diagram illustrating an example of the operation of the optical disk drive shown in FIG. 1.

### DETAILED DESCRIPTION OF THE INVENTION

An embodiment of the present invention will now be described with reference to the accompanying drawings.

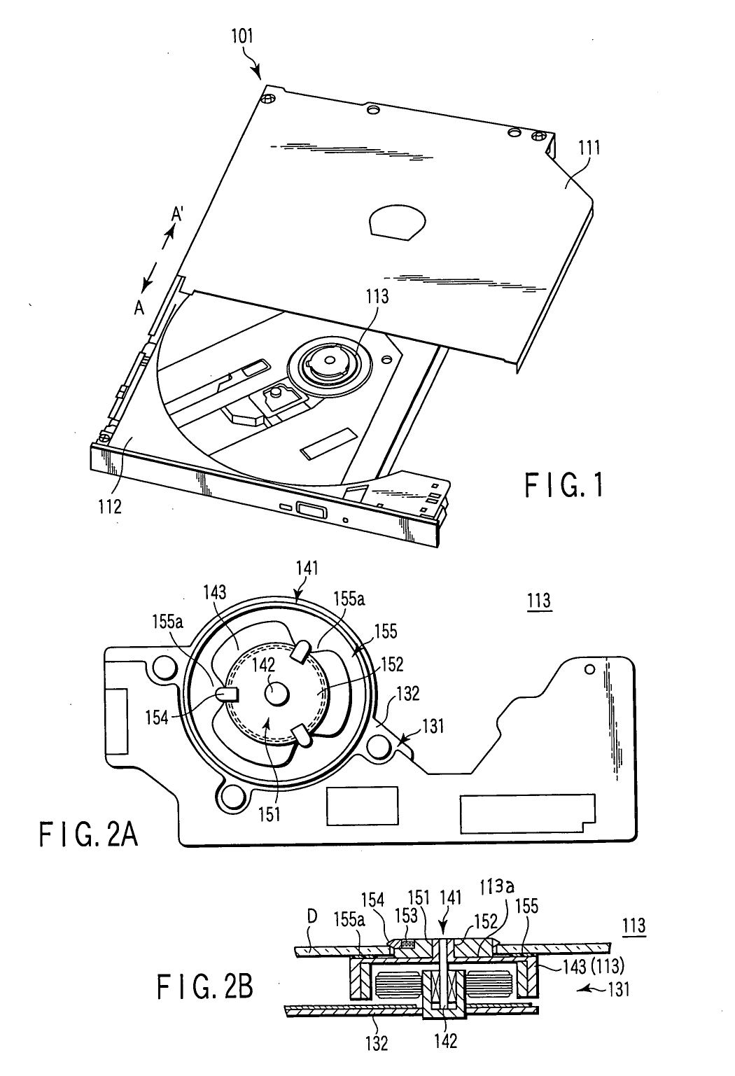

FIG. 1 is a schematic view illustrating an example of an optical disk drive to which an embodiment of the present invention is applicable.

As is shown in FIG. 1, an optical disk drive 101 includes a housing 11 and a drawer unit 112 that is configured to be able to perform an eject operation (movement in the direction of an arrow A) and a loading operation (movement in the direction of an arrow A′), relative to the housing 11.

A turntable 113 for rotating an optical disk (information recording medium) D with a predetermined number of revolutions is provided at a predetermined position on the drawer unit 112.

The drawer unit 112 includes a pickup drive mechanism that moves an optical pickup including an objective lens in a direction of the radius of the optical disk D (details being omitted) and a motor unit including a spindle motor that rotates the optical disk D set on the turntable 113 at a predetermined number of revolutions, as will be described in greater detail referring to FIG. 2A and FIG. 2B.

FIG. 2A and FIG. 2B is a schematic view illustrating an example of the motor unit that is built in the drawer unit 112 shown in FIG. 1. FIG. 2A is a plan view showing a region including the motor unit and spindle motor. FIG. 2B is a cross-sectional view of the region including the spindle motor, taken along the axis of the shaft of the motor.

As is shown in FIG. 2A and FIG. 2B, a motor unit 131 including the turntable 113 includes a spindle motor 141 and a chucking mechanism 151. The spindle motor 141 is supported on a motor base 132. The chucking mechanism 151 is provided on a table surface 113a of the turntable 113 that is fixed to a shaft 142 of the spindle motor 141. The turntable 113 doubles as a rotor 143 that is secured to the shaft 142 of the spindle motor 141.

The chucking mechanism 151 includes a boss portion 152, springs 153 and chucking claws 154. The boss portion 152 is put in contact with, and rotated along with, the turntable 113 and the shaft 142. The springs 153 are disposed at predetermined positions of the boss portion 152 so as to be able to exert forces of reaction in predetermined directions relative to the axis of the boss portion 152. Each of the chucking claws 154 is configured to be movable in a predetermined direction relative to the axis of the boss portion 152 by a force of reaction exerted by the associated spring 153, thereby holding the optical disk (to-be-held object) D on the turntable 113. In this example, three springs 153 and three chucking claws 154 are disposed concentrically with the shaft 142 or boss portion 152 at three equidistant positions on a circumference that is defined by a predetermined radius.

An elastic member 155 that holds the optical disk D is provided on the rotor 143, that is, the turntable 113. The elastic member 155 is formed concentrically with the shaft 142 and boss portion 152 at a predetermined radial position relative to the outer circumference of the turntable 113.

The elastic member 155 is formed of, e.g. a rubber sheet or a resin sheet with a predetermined thickness. The elastic member 155 has an annular shape, as shown in FIG. 2A. The elastic member 155 includes smooth-out stress portions 155a that are formed at predetermined intervals along the inside diameter of the elastic member 155, with the area of each smooth-out stress portion 155a being increased toward the inside in the direction of the radius. The smooth-out stress portions 155a can smooth out an error in thickness of the optical disk D, an error in shape of the chucking claws, or a variation in spring force of the springs 153.

Each smooth-out stress portion 155a, as shown in FIG. 2B, extends toward the inside diameter part of the elastic member 155 up to a point substantially just below the chucking claw 154, with the optical disk D interposed between the chucking claw 154 and the smooth-out stress portion 155a. Thus, each smooth-out stress portion 155a smoothes out the above-mentioned errors in thickness and shape and variation in spring force, and also absorbs, by its own elastic deformation, the force exerted by the chucking claw 154 to the elastic member 155 via the optical disk D, that is, the urging force (stress) of the chucking claw 154, or the stress from the chucking claw 154 thereby to prevent occurrence of bending moment in the optical disk D. To be more specific, the elastic member 155 includes an outside diameter portion defined by a first radius from the shaft 142, an inside diameter portion defined by a second radius that is less than the first radius of the outside diameter portion, and the reaction portion defined by a third radius that is less than the second radius of the inside diameter portion. Preferably, the radius of the innermost part of the smooth-out stress portion 155a should be set to be slightly less than the radius of the inner part of the optical disk D.

This structure prevents the optical disk D, which is set on the elastic member 155 on the turntable 113, from curving due to the force exerted by the chucking claws 154.

Preferably, the smooth-out stress portions 155a of the elastic member 155 should be provided on only those plan-view areas (in FIG. 2A) that are in phase with (i.e. overlapping with) the associated chucking claws 154. By virtue of this configuration, the work efficiency for attaching the boss portion 154 of the chucking mechanism 151 to the turntable 113 is improved, and the possibility of occurrence of bending moment in the optical disk D is minimized.

As has been described above, according to the present invention, it is possible to prevent the optical disk D, which is set on the turntable (chucking mechanism), from curving in its radial direction by the urging force exerted by the chucking claws of the chucking mechanism and by the force of reaction from the elastic member on the turntable (i.e. the force of reaction that is exerted from the elastic member 155 provided on the turntable 113 and can relax a bending moment caused by a reaction to the force acting in the axial direction of the shaft 142). This feature also contributes to minimizing the clearance that is required between the housing (details being omitted) and drawer unit 112 of the optical disk drive 101.

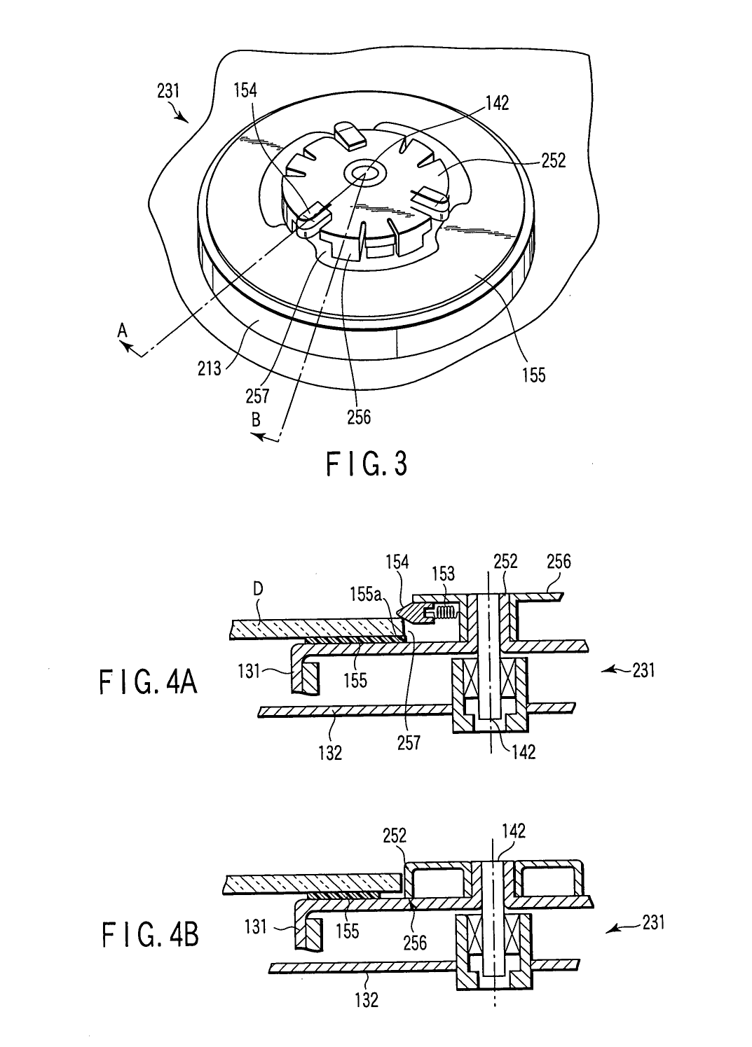

FIG. 3 and FIG. 4A and FIG. 4B are schematic views illustrating another example of the structure of the motor unit shown in FIG. 2A and FIG. 2B. FIG. 3 shows, in enlarged scale, the region of the turntable of the motor unit that is similar to the motor unit shown in FIG. 2A and FIG. 2B. FIG. 4A and FIG. 4B includes schematic cross-sectional views showing a region of a chucking claw and another region of the turntable shown in FIG. 3. In FIGS. 3, 4A and 4B, the parts common to those in FIG. 2A and FIG. 2B are denoted by like reference numerals, and a detailed description is omitted.

As is shown in FIG. 3, a motor unit 231 includes a turntable 213 that is rotated as one body with the shaft 142.

The turntable 213 is provided with a chucking mechanism 252 that is formed concentrically with the shaft 142.

The chucking mechanism 252 includes chucking claws 154, springs 153, and a claw height restricting member 256 (details shown in FIG. 4B). The chucking claws 154 are provided at predetermined positions on a boss portion 252 that is fixed to the shaft 142. The springs 153 urges the chucking claws 154 toward the outside diameter from the center of the shaft 142. The claw height restricting member 256 restricts the height of each chucking claw 154 from the turntable 131.

The claw height restricting member 256 defines spaces (recesses) 257 (shown in FIG. 4A in detail) that accommodate the springs 153, which are formed integral to the boss portion 252, and the chucking claws 154. When the chucking claws 154 are mounted on the boss portion 252, the claw height restricting member 256 prevents the height of each chucking claw 154 (height in the axial direction of boss portion 252) from being undesirably varied. The claw height restricting member 256 is provided in association with the elastic member 155 so as not to contact the smooth-out stress section 155a of the elastic member 155 that is disposed on the turntable 131 concentrically with the shaft 142.

In short, the claw height restricting member 256 can exactly maintain the distance (height) between the chucking claw 154 and the turntable 131 (elastic member 155).

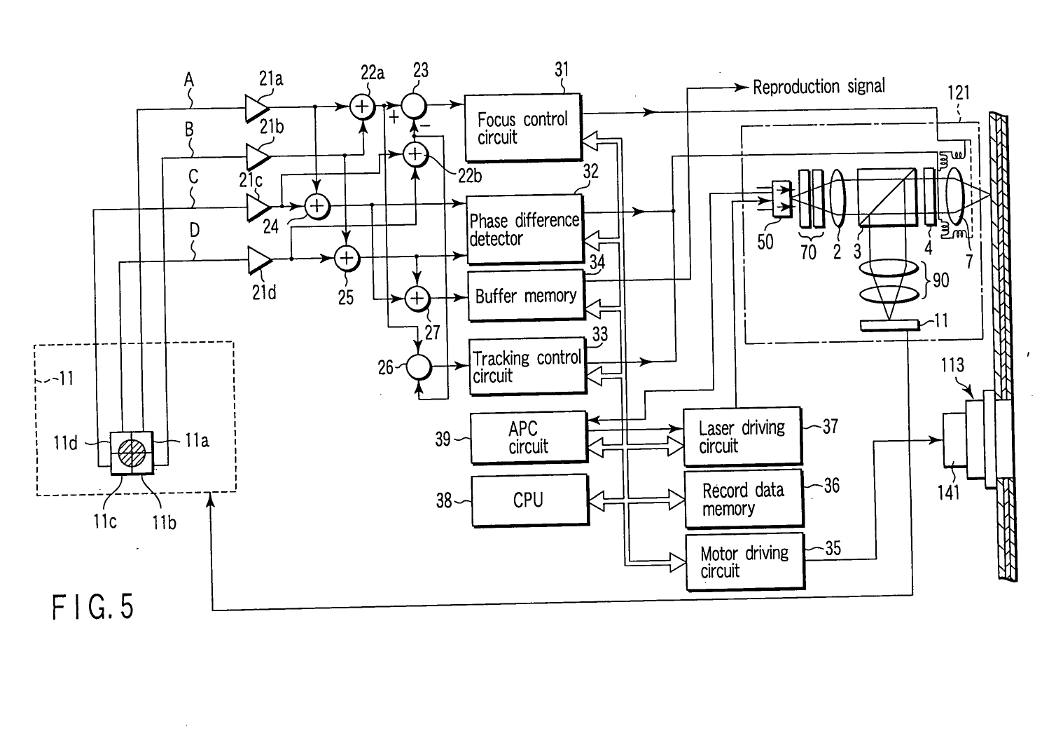

FIG. 5 is a schematic block diagram illustrating an example of the operation of the optical disk drive according to the embodiment shown in FIG. 1.

As is shown in FIG. 5, the optical disk drive has an optical pickup 121 that includes: a light source (laser) 50 including a semiconductor laser capable of emitting a light beam with a predetermined wavelength; an optical member (diffraction element) 70 that imparts predetermined optical characteristics to the beam emitted from the laser 50; a collimator lens 2; a polarizing beam splitter 3; a ¼ wavelength plate 4; an objective lens 7; an astigmatism detection system 90; and a photodetector 11. A description is given mainly of the reproduction of a signal obtained from the photodetector 11 of the optical pickup 121.

The photodetector 11 includes first to fourth region photodiodes 11A, 11B, 11C and 11D. Outputs A, B, C and D from these photodiodes are amplified to a predetermined level by first to fourth amplifiers 21a, 21b, 21c and 21d.

Outputs A and B from the first and second amplifiers 21a and 21b are added by a first adder 22a, and outputs C and D from the third and fourth amplifiers 21c and 21d are added by a second adder 22b. Outputs from the adders 22a and 22b are added by a third adder 23, that is, (C+D) is subtracted from (A+B). An output from the third adder 23 is delivered to a focus control circuit 31 as a focus error signal. The focus error signal makes the position of the objective lens 7 agree with a focal distance, with which the light beam that is converged by the objective lens 7 is focused at a position with a predetermined depth in a track (not shown) or a pit sequence (not shown) formed on the recording surface of the optical disk D.

On the other hand, an adder 24 produces an output of (A+C), and an adder 25 produces an output of (B+D). A phase difference detector 32 receives (A+C) and (B+D). The phase difference detector 32 is advantageous since it exactly outputs a tracking error signal, even where the objective lens 7 is shifted.

An adder 26 produces a sum of (A+B) and (C+D) and delivers it to a tracking control circuit 33 as a tracking error signal.

An adder 27 adds (A+C) and (B+D) and outputs an added signal (A+B+C+D), that is, a reproduction signal. The reproduction signal is stored in a buffer memory 34.

An APC circuit 39 receives the intensity of return light from the laser 50. Based on record data stored in a record data memory 36, the APC circuit 39 controls the intensity of the light beam emitted from the laser 50 at a predetermined level.

In the optical disk drive 101 having the above-described signal detection system, the optical disk D is set on the turntable 113 and a CPU 38 effects a control to execute a predetermined routine. Then, a motor drive circuit 35 rotates the spindle motor 141 with a predetermined speed, and a laser drive circuit 37 controls the laser 50 to emit a laser beam for reproduction to the recording surface of the optical disk D.

Subsequently, the laser 50 continuously emits the laser beam for reproduction, and a signal reproduction operation begins, although details are omitted here.

The present invention is not limited to the above-described embodiments. Various modifications can be made in practice without departing from the spirit of the invention. The embodiments, when practiced, may be combined as much as possible, and advantageous effects can be obtained from such combinations.

As has been described above in detail, in the optical disk drive of the present invention, the chucking mechanism provided on the turntable can hold the optical disk by the urging force for urging the optical disk toward the turntable and by the elastic member that produces a force of reaction to the urging force so as not to cause a bending moment. Thereby, the optical disk is prevented from curving in its radial direction.

Accordingly, the clearance that is required between the housing and drawer unit of the optical disk drive can be minimized, and the thickness of the drive can be reduced.

Furthermore, neither the number of parts nor the number of assembly steps of the chucking mechanism increases. Besides, the manufacturing cost does not increase.

1. A disk support mechanism comprising:
a turntable having a surface extending perpendicular to a rotational shaft thereof, the turntable supporting a to-be-supported object;
a claw member that applies an urging force in a direction parallel to the rotational shaft, with the object interposed between the turntable and the claw member; and
an elastic member that is formed on the turntable concentrically with the rotational shaft and produces a force of reaction capable of relaxing a bending moment that is caused by a reaction to the urging force in the direction parallel to the rotational shaft.

2. The disk support mechanism according to claim 1, wherein the elastic member has a sheet-like shape and includes an outside diameter portion defined by a first radius from a center of the rotational shaft, an inside diameter portion defined by a second radius that is less than the first radius of the outside diameter portion, and a reaction portion defined by a third radius that is less than the second radius of the inside diameter portion.

3. The disk support mechanism according to claim 2, wherein the third radius of the reaction portion is more than a distance between a center of the rotational shaft and the claw member.

4. The disk support mechanism according to claim 2, wherein the reaction portion is situated in phase with the claw member, as viewed in an axial direction of the rotational shaft.

5. The disk support mechanism according to claim 3, wherein the reaction portion is situated in phase with the claw member, as viewed in an axial direction of the rotational shaft.

6. An optical disk drive comprising:
a disk motor including (i) a motor base that rotatably holds a rotational shaft, (ii) a rotor fixed to the rotational shaft, (iii) a medium holding mechanism that is able to apply an urging force to the rotor in a direction parallel to an axis of the rotational shaft, at a predetermined radial position from a center of the rotational shaft, and positions a recording medium so as to be rotatable along with the rotor, and (iv) an elastic member that is formed on the rotor concentrically with the rotational shaft and applies to the medium holding mechanism a force of reaction capable of relaxing a bending moment that is caused by a reaction to the urging force from the medium holding mechanism, in a state in which the recording medium is interposed between the medium holding mechanism and the elastic member, said elastic member having a sheet-like shape and including an outside diameter portion defined by a first radius from the rotational shaft, an inside diameter portion defined by a second radius that is less than the first radius of the outside diameter portion, and an reaction portion defined by a third radius that is less than the second radius of the inside diameter portion;
an optical head that emits light to the recording medium and reproduces information recorded on the recording medium on the basis of the light reflected by the recording medium; and
a motor control unit that rotates the disk motor at a predetermined speed.

7. The optical disk drive according to claim 6, wherein the third radius of the reaction portion is more than a distance between a center the rotational shaft and the predetermined radial position where the urging force applied by the medium holding mechanism works.

8. The optical disk drive according to claim 6, wherein the reaction portion is situated in phase with the medium holding mechanism, as viewed in an axial direction of the rotational shaft.

9. The optical disk drive according to claim 7, wherein the reaction portion is situated in phase with the medium holding mechanism, as viewed in an axial direction of the rotational shaft.

10. A disk support mechanism comprising:
a turntable having a surface extending perpendicular to a rotational shaft thereof, the turntable supporting a to-be-supported object;
a claw member that applies an urging force in a direction parallel to the rotational shaft to the to-be-supported object that is loaded on the turntable;
a claw height restricting member that keeps at established interval between the claw member and the turntable; and
an elastic member that is formed on the turntable concentrically with the rotational shaft and produces a force of reaction capable of relaxing a bending moment that is caused by a reaction to the urging force in the direction parallel to the rotational shaft.

11. A disk support mechanism comprising:
a turntable having a surface extending perpendicular to a rotational shaft thereof, the turntable supporting a to-be-supported object;
a support member that is disposed on the turntable concentrically with the rotational shaft and applies, when the to-be-supported object is loaded, a force to the to-be-supported object at least at three locations, said force acting in an axial direction of the rotational shaft away from the surface of the turntable; and
a disk chucking member that receives said force from the support member and produces a force of reaction capable of putting the to-be-supported object in close contact with the support member.

12. A motor unit comprising:
a motor base;
a rotational shaft that is rotatably held by the motor base;
a rotor fixed to the rotational shaft;
a medium holding mechanism that is able to apply an urging force to the rotor in a direction parallel to an axis of the rotational shaft, at a predetermined radial position from a center of the rotational shaft, and positions a recording medium so as to be rotatable along with the rotor; and
an elastic member that is formed on the rotor concentrically with the rotational shaft and applies to the medium holding mechanism a force of reaction capable of relaxing a bending moment that is caused by a reaction to the urging force from the medium holding mechanism, in a state in which the recording medium is interposed between the medium holding mechanism and the elastic member, said elastic member having a sheet-like shape and including an outside diameter portion defined by a first radius from the rotational shaft, an inside diameter portion defined by a second radius that is less than the first radius of the outside diameter portion, and an reaction portion defined by a third radius that is less than the second radius of the inside diameter portion.
